(19) United States
(12) Patent Application Publication
(10) Pub. No.: US 2014/0053189 A1
(43) Pub. Date: Feb. 20, 2014

(54) APPARATUS AND METHOD FOR PROVIDING PERSONALIZED HOME SCREEN

(71) Applicant: Electronics and Telecommunications Research Institute, Daejeon-si (KR)

(72) Inventors: Sang-Yun LEE, Daejeon-si (KR); Sang-Taick PARK, Seoul (KR); Jin-Woo HONG, Daejeon-si (KR); Tae-Gun KANG, Daejeon-si (KR); Seung-Chul KIM, Daejeon-si (KR); Seung-Hee KIM, Daejeon-si (KR); In-Cheol JEONG, Daejeon-si (KR)

(73) Assignee: Electronics and Telecommunications Research Institute, Daejeon-si (KR)

(21) Appl. No.: 13/949,576

(22) Filed: Jul. 24, 2013

(30) Foreign Application Priority Data
Aug. 17, 2012 (KR) 10-2012-0090262
Jun. 4, 2013 (KR) 10-2013-0064263

(51) Int. Cl. H04N 21/485

(52) U.S. Cl. CPC H04N 21/4858
USPC 725/37

(57) ABSTRACT

Provided is an apparatus for providing a personalized home screen, and the apparatus includes a user identification unit configured to receive user identification information comprising login information and biometric information of a user; and a home screen processing unit configured to identify the user by comprising the received user identification information with a collection of user personal information of multiple users and searching for user personal information corresponding to the received user identification information, and to display a personalized home screen based on the user personalization information of the identified user.

### CROSS-REFERENCE TO RELATED APPLICATION

This application claims the benefit under 35 U.S.C. §119(a) of Korean Patent Application Nos. 10-2012-0090262, filed on Aug. 17, 2012, and 10-2013-0064263, filed on Jun. 4, 2013, in the Korean Intellectual Property Office, the entire disclosure of which is incorporated herein by reference for all purposes.

### BACKGROUND

1. Field

The following description relates to a home screen in a smart TV, and, more particularly, to an apparatus and a method for providing a different personalized home screen to each user.

2. Description of the Related Art

Television (TV) is the most popular means to provide information and content, and a conventional TV conveys a broadcast to a user in one way. Due to developments and popularization of Personal Computer (PC) and the Internet, people have recently paid more attention to bidirectional broadcast service and demand for bidirectional broadcast service have led to advent of a smart TV.

The smart TV refers to a multi-functional TV which is embedded with an Operating System (OS) and a Central Processing Unit (CPU) and capable of accessing the Internet. Using the smart TV, the user is able to surf websites, watch a Video on Demand (VOD), enjoy Social Networking Service (SNS) and play a game, as well as watching TV. As various menus are displayed on a default screen (hereinafter, referred to as a home screen) of a smart phone, such as a smart phone and a tablet PC, a user may enjoy content and applications more conveniently and instantly.

A conventional smart TV provides various users with the same home screen, regardless of personal tastes and usage patterns. Since each user may favor different broadcasts and applications, providing the same home screen to multiple users is not a good way of establishing convenient user environment and cannot fulfill a user's satisfactions.

### SUMMARY

In one general aspect, there is provided an apparatus for providing a personalized home screen, the apparatus including a user identification unit configured to receive user identification information including login information and biometric information of a user; and a home screen processing unit configured to identify the user by comparing the received user identification information with a collection of user personal information of multiple users and searching for user personal information corresponding to the received user identification information, and to display a personalized home screen based on the user personalization information of the identified user. The biometric information may include at least one of iris information, fingerprint information, facial shape information and voice information.

In response to not storing user personal information corresponding to the received user identification information, the home screen processing unit may request the user personal information from a cloud server storing the collection of user personal information of multiple users, receive the user personal information from the cloud server, and compare the user identification information with the user personal information received from the cloud server.

In another general aspect, there is provided a method for providing a personalized home screen, the method including collecting user identification information from a user; comparing the collected user identification information with a collection of user personal information data of multiple users; identifying the user based on user personal information corresponding to the user identification information; and displaying a personalized home screen optimized for the user based on the user personal information.

In still another general aspect, there is provided an apparatus for providing a personalized home screen using a mirror-type smart remote controller, the apparatus, which displays a personalized home screen corresponding a user identified based user identification information received from the user, including a mirror-type smart remote controller configured to have a touch screen interface, duplicate an image displayed in the apparatus, display the duplicated image, and edit the personalized home screen using the touch screen interface. The mirror-type smart remote controller may include an application installed in a smart device, edit a size or a location of the application composing the personalized home screen, and set a layout of the personalized home screen based on a touch input received from the user.

In yet another general aspect, there is provided an edition method of an apparatus for providing a personalized home screen, the edition method including duplicating an image, displayed on a TV screen, in real time using a smart phone, smart pad or an exclusive TV remote controller; displaying the duplicated image; and editing the personalized home screen using a mirror-type smart remote controller in the form of application, which is capable of controlling TV functions. Since the mirror-type smart remote controller duplicates the image and transmits a control signal, such as an event and a multi-touch, from the mirror-type smart remote controller to a TV, a user is able to change a layout of a home screen of TV in any way the user wishes. The changing of the layout may include reducing or enlarging a TV image screen into an arbitrary size using the multi-touch, changing a location of the TV image screen using a drag-and-drop function, changing a size and a location of an icon for an installed application, shifting one page of a paginated home screen into another page, and classifying applications as one group.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of an apparatus for providing a personalized home screen according to an exemplary embodiment of the present invention;

FIG. 2 is a diagram illustrating a configuration of a home screen processing unit according to an exemplary embodiment of the present invention;

FIG. 3 is a diagram illustrating a configuration of a user data storage unit in a home screen processing unit according to an exemplary embodiment of the present invention;

FIG. 4 is a diagram illustrating a configuration of an input unit according to an exemplary embodiment of the present invention;

FIG. 5A is a diagram illustrating a user identification unit using an image input unit according to an exemplary embodiment of the present invention;

FIG. 5B is a diagram illustrating a user identification unit using a voice input unit;

FIG. 5C is a diagram illustrating a user identification unit using a login process;

FIG. 6A is a diagram for explaining an example in which an apparatus for providing a personalized home screen provides different home screens to different users;

FIG. 6B is a diagram for explaining an example in which different apparatuses for providing a personalized home screen provides the same home screen to different users;

FIG. 6C is a diagram for explaining an example in which an apparatus for providing a personalized home screen provides a first home screen and a second home screen to the same user;

FIG. 6D is a diagram for explaining an example in which an apparatus for providing a personalized home screen and on a tablet Personal Computer (PC) provides the same personalized home screen the same user;

FIG. 7 is a flow chart illustrating a method for providing a personalized home screen according to an exemplary embodiment of the present invention;

FIG. 8 is a diagram illustrating a configuration of an apparatus for providing a personalized home screen, which uses a mirror-type smart remote controller according to an exemplary embodiment of the present invention;

FIG. 9 is a flow chart illustrating a method for providing a personalized home screen using a mirror-type smart remote controller according to an exemplary embodiment of the present invention; and

FIG. 10 is a diagram illustrating a configuration of a system for providing a personalized home screen, which includes two or more apparatuses for providing a personalized home screen, according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

The following description is designed to provide an apparatus and method for enabling each of multiple users not only to use a different personalized home screen on the same smart TV, but also to use the personalized home screen on another smart TV based on personal information stored in a cloud server. In addition, the following description relates to an apparatus and method for enabling a user to edit and rearrange a personalized home screen.

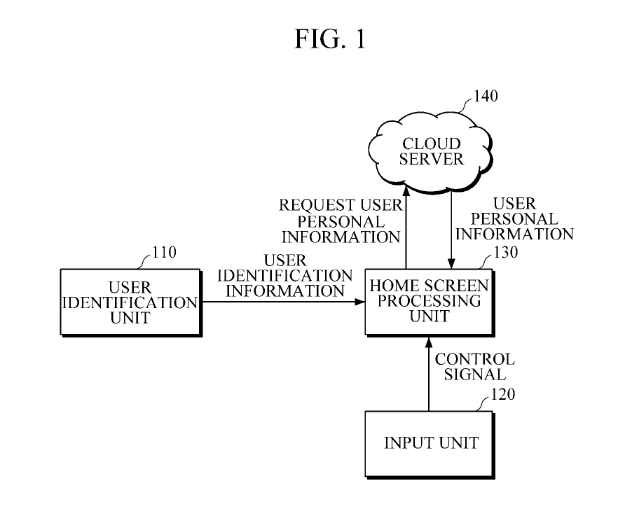

FIG. 1 is a diagram illustrating a configuration of an apparatus for providing a personalized home screen according to an exemplary embodiment of the present invention.

Referring to FIG. 1, the apparatus for providing a personalized home screen includes a user identification unit 110 and a home screen processing unit 130, and further includes an input unit 120.

The user identification unit 110 includes a microphone to collect a voice signal, a fingerprint recognition device, an iris recognition device and a camera device to photograph an image of a user. Not only by using a conventional login process which requires identification (ID) and a password of the user, but also by collecting biometric information, such as facial shape information, fingerprint information, iris information and voice information, the apparatus for providing a personalized home screen may identify the user. In addition to the above-described data collection devices, the user identification unit 110 may include various devices which are capable of collecting information in order to identify a user.

The user identification unit 110 recognizes and/or identifies the user based on signals which are collected from a user. In addition, the user identification unit 110 receives and/or collects identification information on outward features of the user, such as facial shape information, iris information and fingerprint information, or receives a voice signal from the user. The user identification unit 110 transmits the user identification information to the home screen processing unit 130 to identify the user. The user identification information transmitted to the home screen processing unit 130 is used as data when recognizing and/or identifying the user.

In addition, the user identification unit 110 may be configured to be separate from or embedded in the home screen processing unit 130.

The input unit 120 may control the home screen processing unit 130 and the user identification unit 110 from a remote distance, and transmit various signals input by the user to the home screen processing unit 130. Using the input unit 120, the user may control the apparatus for providing a personalized home screen, which includes the home screen processing unit 130 and the user identification unit 110, and input text information. The input unit 120 may include a commonly-used remote controller and a smart phone providing a remote-control function.

The home screen processing unit 130 may receive user identification information from the user identification unit 110, and identify a user by comparing the received user identification information with a collection of user personal information of multiple users. The collection of user personal information of multiple users may be stored in the home screen processing unit 130 or may be received from a cloud server 140.

The home screen processing unit 130 may provide a user with various functions via a home screen, that is, a default screen. While a commonly-used TV provides only a received broadcast, a smart TV provides an application or a stored piece of content upon a user's request as a Personal Computer (PC) and a smart phone do. For the purpose of efficiency in providing services to a user, the home screen may include icons of applications, widgets and a user interface such as a Graphic User Interface (GUI). Via the home screen, the user may execute a desired application and may receive a piece of content.

The home screen processing unit 130 may provide a different home screen to each of multiple users. The multiple users may enjoy different pieces of content, different applications and different GUIs according to usage patterns and personal tastes. For this reason, the home screen processing unit 130 stores a home screen optimized for each user, that is, a personalized home screen, and provides the stored personalized home screen to a corresponding user. Each user may personalize a home screen in advance by setting or editing the home screen to be optimized for the user, or may select a suitable home screen from among a plurality of home screens set by a manufacturer or other users.—In addition, a user may arrange an icon for a frequently-used application at a desired location, and adjust a size and a location of an execution screen of the application. For example, a user may set a video reproduction application to be executed with a full-size screen or with a predetermined-size screen at a predetermined location on the home screen. In the case of using a smart TV, a user may set a TV image screen to be displayed with a full-size screen or with a predetermined-size screen at a predetermined location on a home screen. In this way, a user may enjoy two or more applications or TV image screens at the same time.

A plurality of personalized home screens are stored in the home screen processing unit 130. The home screen processing unit 130 identifies a user based on user identification information received from the user identification unit 110 or based on ID and a password of the user, and then displays a personalized home screen corresponding to the identified user.

The home screen processing unit 130 stores usage pattern information of each user. The usage pattern information includes user-preferred video information and primary program information. The user-preferred video information includes a list of applications or pieces of content, which are frequently used by a user, favorite websites, bookmarks in a web browser, and Youtube search keywords input by the user. The primary program information includes types, titles and primarily watching time of programs used by the user. In addition, the home screen processing unit 130 stores and manages home screen information which includes a layout, a theme and a GUI of a home screen corresponding to each user.

The user personal information, the home screen information and the usage pattern information may be stored in the home screen processing unit 130 to identify the user and provide a personalized home screen corresponding to the user. Alternatively, the user personal information, the home screen information and the usage pattern information may be stored in the cloud server 140 and transmitted to the home screen processing unit 130 in response to a request from a user. In this way, the user may be provided with the same home screen, regardless of a type of the home screen processing unit 140. For example, a user may use a home screen, which is displayed on a smart TV in a living room, on a smart TV in another room. Even when using a smart TV in a place other than home, the user may be provided with the same home screen by accessing the cloud server 140 to receive information on the home screen. In addition, the user may be provided with the same home screen not only on a smart TV but also on other various smart devices such as a smart phone and a tablet Personalized Computer (PC).

The cloud server 140 stores the user personal information, the home screen information and the usage pattern information, each received from the home screen processing unit 130. In response to a request from the home screen processing unit 130, the cloud server 140 transmits the user personal information, the home screen information and the usage pattern information to the home screen processing unit 130.

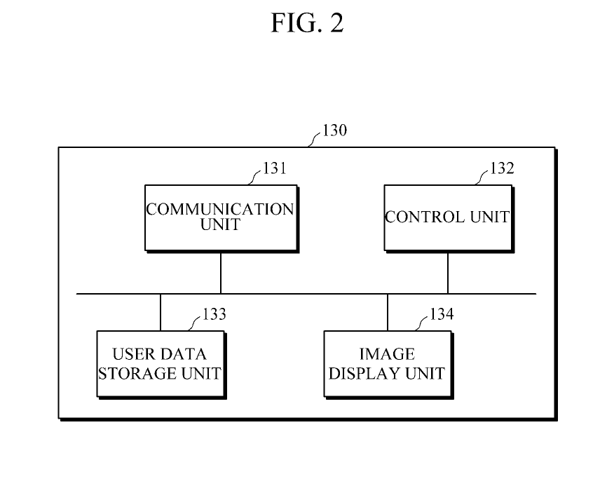

FIG. 2 is a diagram illustrating a configuration of a home screen processing unit according to an exemplary embodiment of the present invention.

Referring to FIGS. 1 and 2, the home screen processing unit 130 includes a communication unit 131, a control unit 132, a user data storage unit 133 and an image display unit 134.

The communication unit 131 includes a wireless and/or wired communication interface which enables transmission and reception of data with respect to the user identification unit 110, the input unit 120 and the cloud server 140. The home screen processing unit 130 may receive user identification information from the user identification unit 110 via the communication unit 131, and receive a control command and text information from the input unit 120 via a local wireless communication interface such as an infrared communication module and a Bluetooth module. In addition, the home screen processing unit 130 may transmit and/or receive data with respect to the cloud server 140 and a service provider by accessing an Internet network via a wired/wireless Local Area Network (LAN) interface.

The control unit 132 may identify a user by comparing the user identification information received from the user identification unit 110 with a collection of user personal information of multiple users stored in the user data storage unit 133 or the cloud server 140. The user identification information collected by the user identification unit 110 is transmitted to the control unit 132 of the home screen processing unit 130.

The control unit 132 receives the user identification information from the user identification unit 110, and then verifies biometric information contained in the received user identification information. The biometric information included in the user identification information may include facial shape information, fingerprint information, iris information and voice information of the user. Then, the control unit 132 searches the user data storage unit 133 for user personal information corresponding to the verified result of the biometric information or may request the user personal information from the cloud server 140. By comparing the biometric information contained in the user identification information with biometric information in user personal information which is stored in the user data storage unit 133 or received from the cloud server 140, the control unit 132 may recognize the user and determine whether the user is suitable for receiving a personalized home screen. For example, if a user has been registered, a personalized home screen corresponding to the user may be provided. In another example, if a user has not been registered, a basic home screen may be provided.

In addition, the control unit 132 may provide a user with a personalized home screen based on usage pattern information stored in the user data storage unit 133. That is, the control unit 132 may provide the user with a personalized home screen whose GUI is optimized for the user based on a layout of the home screen, which is set in advance by the user, and the usage pattern information which includes program viewing history, bookmarks and a list of used pieces of content. For example, according to settings made by a user, the control unit 132 may provide a TV image screen with a predetermined-size screen at a predetermined location on a home screen, and may arrange an execution screen of an application in a different area on the home screen. In addition, in the case where the control unit 130 analyzes user pattern information to be informed that a recognized user watches a specific program on a predetermined point in time using the home screen processing unit 130, if the user requests the specific program from the home screen processing unit 130, the control unit 130 may display, at the center of a home screen, a small-sized screen for displaying the program or a menu for instantly putting on the program.

In addition, the control unit 132 may execute an application or reproduce a piece of content according to a control signal received from the input unit 120 and display in the image display unit 134 an execution result of the application or a reproduction result of the piece of content. In addition, the control unit 132 may display text information received from the input unit 120 in the image display unit 134, or may input the text information to a corresponding application or web browser. For example, text information, including a website address or a Social Networking Service (SNS) message, may be input by the control unit 132 to a corresponding web browser or SNS to thereby access a corresponding website.

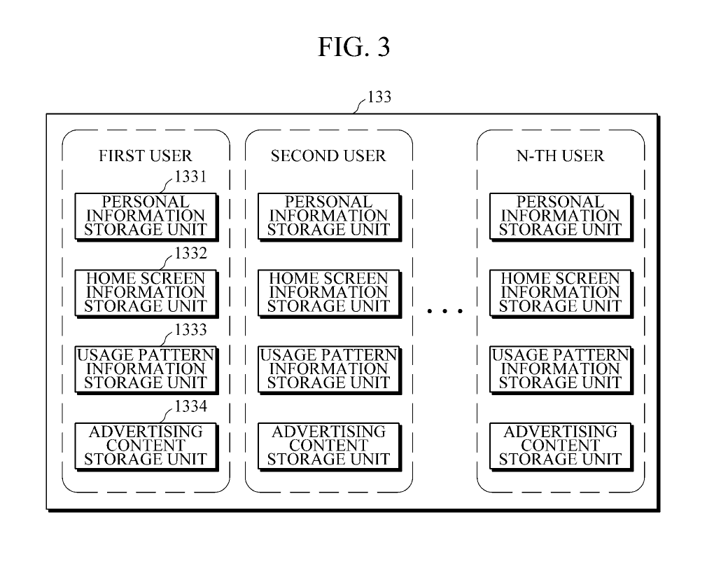

The user data storage unit 133 stores received user personal information, received home screen information and received usage pattern information. The user personal information, the home screen information and the usage pattern information are classified according to users for storage and management. In addition, the user data storage unit 133 may further include information about a piece of advertisement content. The user data storage unit 133 will be further described in detail with reference to the following FIG. 3.

The image display unit 134 displays information in the form of an image on a screen. In more detail, the image display unit 134 displays an image on a screen by receiving an image signal about a home screen, a piece of content, an application and an advertisement. The image display unit 134 may include a Cathode Ray Tube (CRT) and a Liquid-Crystal Display (LCD), which are commonly used in televisions and monitors. However, the image display unit 134 is not limited thereto, and may include any device which is capable of displaying an image on a screen.

FIG. 3 is a diagram illustrating a configuration of a user data storage unit according to an exemplary embodiment of the present invention.

Referring to FIG. 3, a user data storage unit 133 of a home screen processing unit includes a user personal information storage unit 1331, a home screen information storage unit 1332, a usage pattern information storage unit 1333 and an advertisement content storage unit 1334 on a per-user basis.

The user personal information storage unit 1331 stores a collection of user personal information classified according to users. User personal information may include biometric information of a user or the user's ID and password necessary for a login process. In more detail, the biometric information may include facial shape information, fingerprint information, iris information and voice information of the user, which are collected by the user identification unit 110. The user personal information is used to identify the user in response to a request for a home screen from the user.

The home screen storage unit 1332 stores home screen information classified according to users. The home screen information includes a layout, a theme and a Graphical User Interface (GUI) of a home screen, which are set or selected by a user. The user may set a layout of a home screen according to the user's personal tastes and usage patterns to arrange icons of applications and widgets, so that the user may optimize and/or personalize the GUI for the sake of convenience. In addition, the user may set a theme of a home screen to have a background screen and a background sound reflecting the user's personal tastes or interest. In this manner, the user may be provided with a home screen which is personalized based on the home screen information and reflects the user's personal tastes and interest.

The usage pattern information storage unit 1333 stores usage pattern information classified according to users. The usage pattern information includes bookmarks set by a user in a web browser, a list of applications, a smart TV viewing time and a smart TV usage history of the user. The usage pattern information collected from a user may include viewing history information, for example, search keywords in a search engine, information on VODs that the user frequently watches, smart TV viewing time, and a time log. If the user requests a home screen, a specific piece of content or a specific application may be highlighted based on usage pattern information corresponding to the user or an interface which allows the user to easily access the home screen may be provided. For example, if a user watches a news program on a predetermined point in time, a preview for the news program is provided on a home screen, and thus the user may enjoy the new program more conveniently.

The usage pattern storage unit 1333 may include a channel list management unit configured to manage a list of a user's favorite channels, a bookmark management unit configured to share information on bookmarks in a web browser, a VOD list management unit configured to manage a list of VODs and found videos on YouTube, and a viewing history information management unit configured to store and manage viewing pattern information including names and viewing time of viewed programs.

The advertisement content storage unit 1334 stores advertisement content information classified according to users. The advertisement content information includes advertisements permitted by a user and relevant product information. When the user is watching a specific piece of content or executing a specific application, the advertisement content information may be provided together. The advertisement content enables the user to enjoy a piece of content or an application for free or at inexpensive costs.

TABLE 1
The following table shows home screen information and usage
pattern information included in the usage data storage unit 133
of a home screen processing unit according to an
exemplary embodiment of the present invention.
Home Screen Information and Usage Pattern Information

| Cloud User ID | Cloud_ID_0001 | | |
|---|---|---|---|
| Home Profile | Profile B | | |
| | Profile A | Profile B | Profile C |
| My Channel List | KBS1, TV | MBC, OCN | SBS, EBS, |
| | Chosun | | OCN |
| Home Screen A | A.xml | B.xml | C.xml |
| layout | | | |
| Schedule Recording | MBC/2012.08.15 14:00~18:00 | | |
| of Broadcast | | | |
| Internet Bookmark | Mybook1.html | Mybook2.html | Mybook3.html |
| Broadcast Preference | Drama, Movie | Sports, Game | SNS, Web |
| Information | | | Browser |
| . . . | . . . | . . . | . . . |

In Table 1, the cloud user ID is used to access a user's personal information stored in a cloud server in response to a request for user identification, which is received through a user button 121 of the input unit 120. The home profile is a default one out of a plurality of profiles. Each of the profiles A, B and C is home screen information and usage pattern information, which are set by a user. Setting three profiles is merely an example, and a user may set profiles more or less than three. Each profile includes information on a frequently-viewed or frequently-used piece of content, Internet bookmarks and broadcast preference information. In addition, each profile further includes a home screen a layout set by the user. The home screen a layout may be written in Extensible Markup Language (XML).

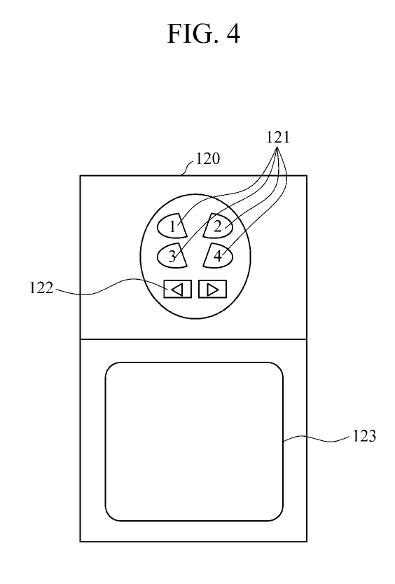

FIG. 4 is a diagram illustrating an input unit according to an exemplary embodiment of the present invention.

Referring to FIG. 4, an input unit 120 includes first-user to fourth-user buttons 121, a search button 122 and a function button 123.

Using the first-user to fourth user buttons 121, each of four different users is able to select a distinctive home screen. According to an exemplary embodiment of the present invention, an apparatus for providing a personalized home screen may provide a different home screen to each user by identifying the user in a user identification unit. However, in the case where a smart TV is utilized at home, family members are the main users of the smart TV. Thus, it may cause huge inconvenience to identify a user in a user identification unit each time the user attempts to watch the smart TV, because people other than the family members are unlikely to use the smart TV at home. For this reason, it is possible to provide a personalized home screen using a user button 121, by setting each of the user buttons 121 to correspond to a different user (that is, a different family member). Each of the user buttons 121 may be distinguished with an attached number, character, shape and user's picture on a surface thereof. The number of the user buttons 121 of the input unit 120 is not limited to four, may vary in accordance with the number of users and a location where the smart TV is installed.

TABLE 2
The following table shows information which is set in the
input unit 120 according to another exemplary embodiment
of the present invention.
Home Screen Setting Information Set in Input Unit

| | Home User ID | Cloud User ID |
|---|---|---|
| First-user Button | First user | Cloud_ID_0001 |
| Second-user Button | Second user | Cloud_ID_0002 |
| Third-user Button | Third user | Cloud_ID_0003 |
| Fourth-user Button | Fourth user | Cloud_ID_0004 |
| . . . | . . . | . . . |

Table 2 may include a row in which home user IDs corresponding to a plurality of user buttons 121 of the input unit 120 are arranged, and a row in which cloud user IDs used for obtaining information from a cloud server are arranged. Each of the home user IDs is used to access user personal information stored in and managed by a home screen processing unit 130, when user identification is requested using the user button 121 of the input unit 120. In addition, each of the cloud user IDs is used to access user personal information stored in the cloud server, when user identification is requested using the user button 121 of the input unit 120.

If the number of users is greater than the number of the user buttons 121, the entire users are classified into a plurality of groups, and each group is set to consist of users as many as the number of the user buttons 121 and to be selected using the search button 122. In this way, it is possible to assign the user buttons 121 to multiple users.

The function button 123 includes a button which has a plurality of functions included in a general remote controller. Using the function button 123, a user is able to change a channel and control volume, and select and control a piece of content or an application. In addition, the is function button 123 may have a text input function to input text information, thereby making it easy and convenient to utilize SNS and a web browser.

The input unit 120 described with reference to FIG. 4 is merely an example and is not limited to the description above. Thus, the input unit 120 may include a commonly-used remote controller and any device which has functions similar to those of the remote controller. In addition, the input unit 120 illustrated in FIG. 4 may be developed into both hardware and software. For example, an application with the functions described above may be utilized as the input unit 120.

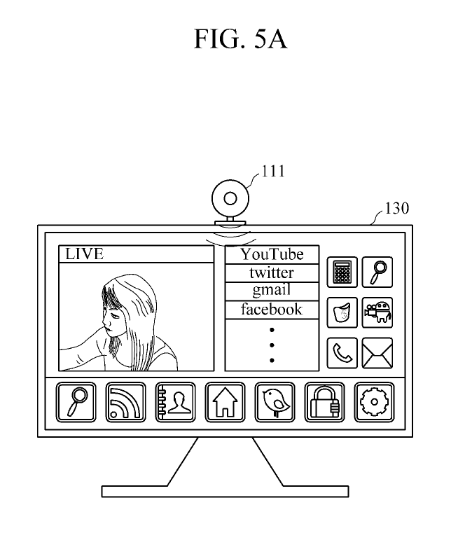

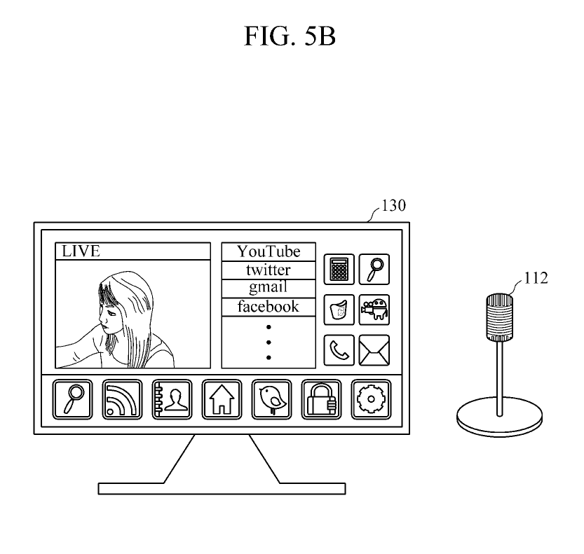

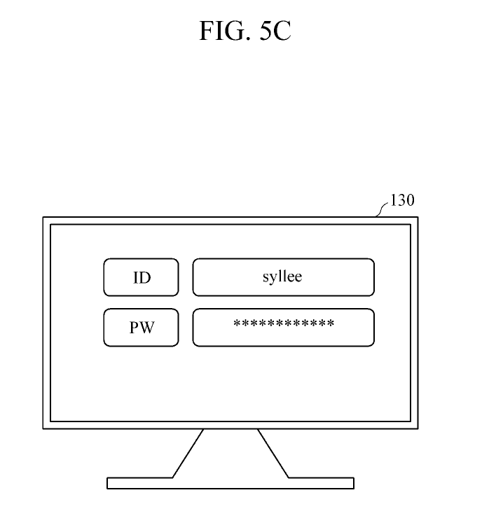

FIG. 5A is a diagram illustrating an example of a user identification unit using an image input unit according to an exemplary embodiment of the present invention.

Referring to FIG. 5A, a user identification unit 111 using the image input unit collects a user's biometric information by photographing the user. The user identification unit 111 using the image input unit may include a camera, a camcorder and a fingerprint recognition device. For example, the user identification unit 111 collects a user's facial shape information by photographing the user's face, and then compares the collected facial shape information compared with a collection of previously-stored facial shape information to search for stored facial shape information corresponding to the collected facial shape information. In this manner, the user identification unit 111 is able to identify the user.

FIG. 5B is a diagram illustrating an example of a user identification unit using a voice input unit.

Referring to FIG. 5B, a user identification unit 112 using the voice input unit collects voice information of the user by receiving the user's voice. Then, the user identification unit 112 may compares the user's voice information with a collection of previously-stored voice information to search for stored voice information corresponding to the collected voice information. In addition, the user identification unit 112 may identify the user by receiving an ID and a password of the user by voice.

FIG. 5C is a diagram illustrating an example of a user identification unit using a login process.

Referring to FIG. 5C, a user identification unit using a login process may identify a user by providing a user with a login interface through an image display unit and receiving an ID and a password from the user through the login interface.

The user identification unit illustrated in FIG. 5C n is not limited thereto, and may employ various methods for identifying a user. For example, the user identification unit may identify a user using iris recognition and fingerprint recognition which utilizes various kinds of biometric information, or using an ID card.

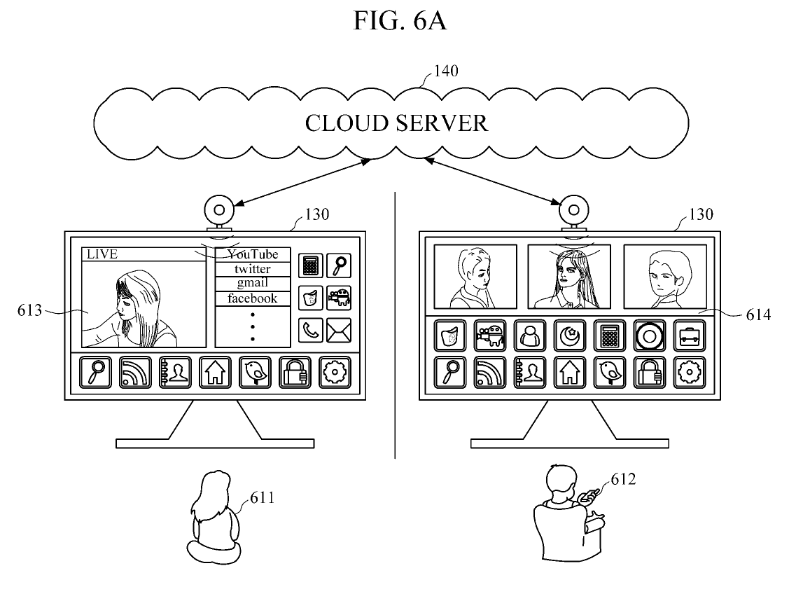

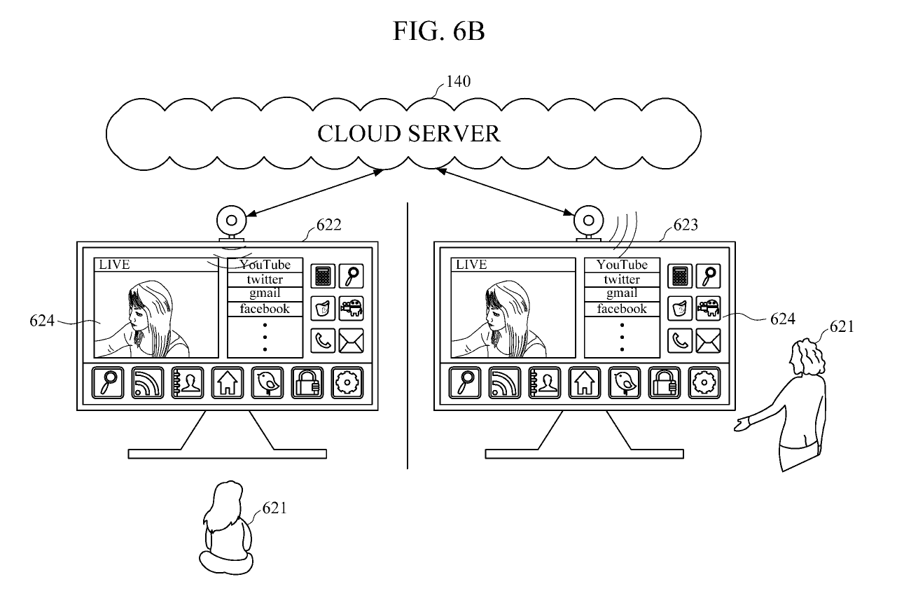

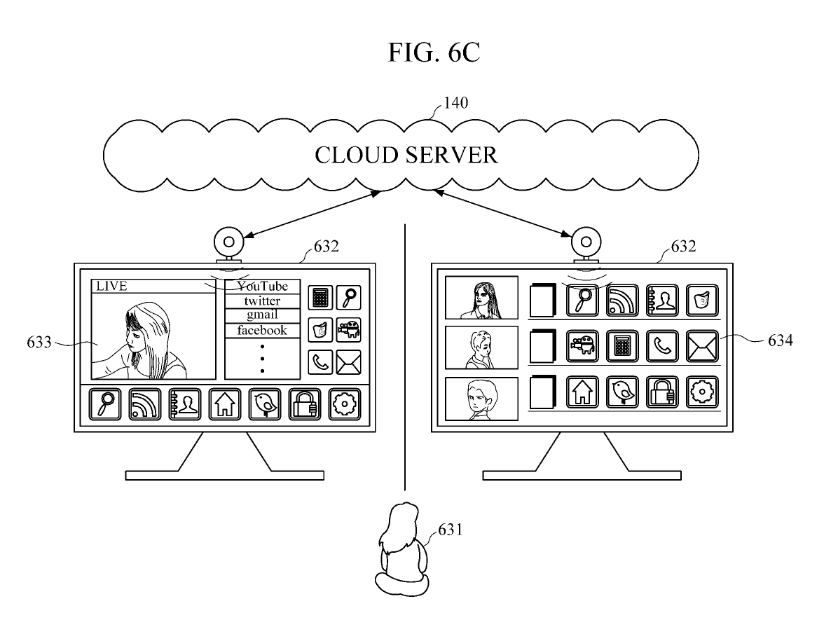

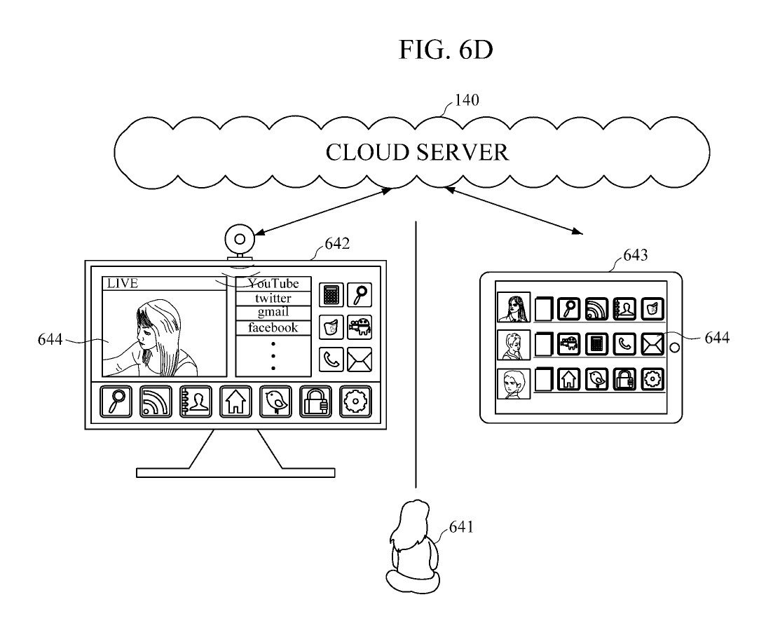

FIG. 6A is a diagram for explaining an example in which the same apparatus for providing a personalized home screen provides different home screens to different users.

Referring to FIG. 6A, an apparatus 130 for providing a personalized home screen may provide different users with different personalized home screens. That is, the apparatus 130 may provides a first user 611 and a second user 612 with a first home screen 613 and a second home screen 614, respectively. By identifying a user in a user identification unit, the apparatus 130 may identify each of the first user 611 and the second user 612, and provide the first user 611 with the first home screen 613 and the second user 612 with the second home screen 614.

FIG. 6B is a diagram for explaining an example in which different apparatuses for providing a personalized home screen provides the same home screen to the same user on different smart TVs.

Referring to FIG. 6B, if a user 621 uses both a first apparatus 622 for providing a personalized home screen and a second apparatus 623 for providing a personalized home screen, both the first apparatus 622 and the second apparatus 623 may provide the same home screen 624. The first apparatus 621 owned by the user 621 may provide the home screen 624 through user identification. Meanwhile, if the second apparatus 622 is equipped in a place other than a home of the user 621 and is not owned by the user 621, the second apparatus 622 may provide the same home screen 642 to the user 621 by receiving user personal information from a cloud server to identify the user.

FIG. 6C is a diagram for explaining an example in which an apparatus for providing a personalized home screen provides a first home screen and a second home screen to a user.

Referring to FIG. 6C, an apparatus 632 may not only provide a single home screen to a single user, but also may provide two or more home screens to a single user. That is, the apparatus 632 is able to provide a user 631 with both a first home screen 633 and a second home screen 634, by switching the first home screen 633 and the second home screen 634 to each other alternatively upon a user's request. For example, the first home screen 633 may be configured to relate to VODs and broadcast programs, whereas the second home screen 634 may be configured to relate to SNS and a web browser.

FIG. 6D is a diagram for explaining an example in which an apparatus for providing a personalized home screen and a tablet PC provide the same home screen to the same user.

Referring to FIG. 6D, if a user 641 uses both the apparatus 642 for providing a personalized home screen and a smart device, such as the tablet PC 643, the same home screen 644 may be provided to the user 641. In this way, the user 641 is able to enjoy the same home screen 644 with various smart devices, so that user convenience may be enhanced.

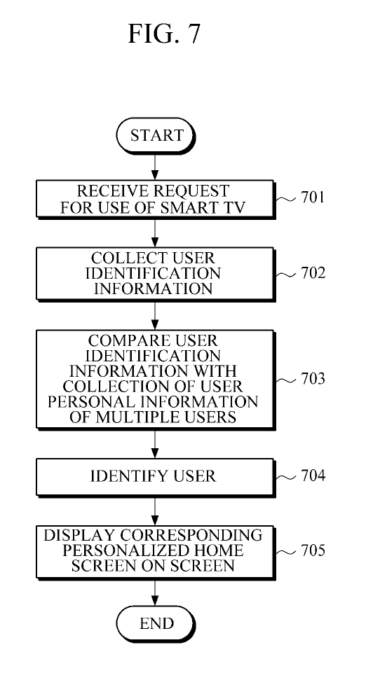

FIG. 7 is a flow chart illustrating a method for providing a personalized home screen according to an exemplary embodiment of the present invention.

Referring to FIG. 7, the method for providing a personalized home screen starts out by receiving a user's request for use of an apparatus for providing a personalized home screen in 701. In response to receiving the user's request input through an input unit, such as a remote controller, the apparatus for providing a personalized home screen is turned on. Then, user identification information is collected from the user in 702. Specifically, the user identification unit collects the user's biometric information, including iris information, fingerprint information, facial shape information and voice information. Alternatively, the apparatus receives an ID or a password from the user, or a signal from a user button of the input unit.

Next, the apparatus compares the collected user identification information with a collection of user personal information of multiple users in 703. The user personal information includes biometric information and login information of the user. The collection of user personal information of multiple users may be stored in the apparatus. If the apparatus has no user personal information corresponding to the user, it is possible to access a cloud server to receive the corresponding user personal information. Then, the apparatus compares the user identification information with the collection of user personal information of multiple users to find user personal information corresponding to the user identification information. If the user identification information is a signal from a user button of the input unit, the apparatus immediately searches for user information corresponding to the user button.

Next, if the apparatus has the user personal information corresponding to the user identification information, the apparatus identifies the user based on the user personal information in 704. That is, if the user personal information corresponding to the received user identification information is found from among the collection of user personal information of multiple users, the apparatus recognizes and/or identifies the user based on the found user personal information. Next, the apparatus displays a personalized home screen corresponding to the found user personal information in 705. If the user is identified based on the user personal information, it is possible to verify usage pattern information and home screen information of the user. The usage pattern information includes bookmarks set by the user and viewing patterns of the user, whereas the home screen information includes a layout, a theme and a GUI of a home screen, which are set by the user. The apparatus displays on a screen a personalized home screen which is optimized for the user based on the usage pattern information and the home screen information of the user. Through the displayed home screen, the user is able to utilize the apparatus for providing a personalized home screen.

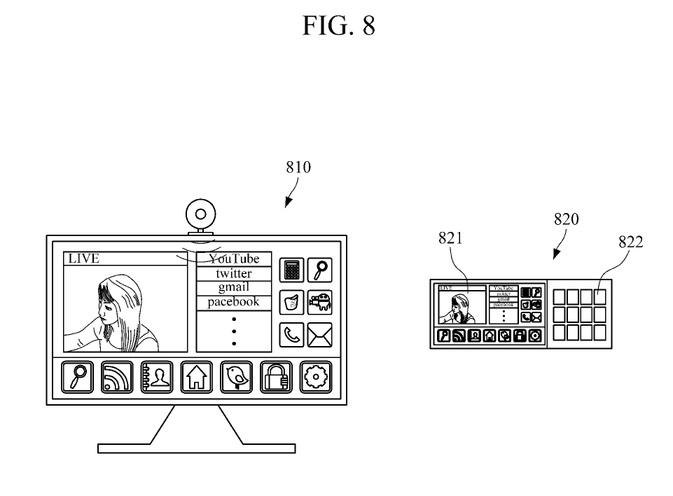

FIG. 8 is a diagram illustrating a configuration of an apparatus for providing a personalized home screen, which utilizes a mirror-type smart remote controller, according to an exemplary embodiment of the present invention.

Referring to FIG. 8, a mirror-type smart remote controller includes an image reproducing screen 821 and manipulation buttons 822.

The image reproducing screen 821 may duplicate an image displayed in an apparatus 810 for providing a personalized home screen and display the duplicated image. Using a touch screen interface or the manipulation buttons 822 which are provided on the image reproducing screen 821, a user is able to edit and set a personalized home screen of the apparatus 810. When editing and setting the personalized home screen of the apparatus 810, the user may use the mirror-type smart remote controller 820 for the sake of convenience.

The mirror-type smart remote controller 820 displays the image reproducing screen 821 which is the same as a screen displayed on the apparatus 810. In addition, if a manipulation or a changed instruction is input via the mirror-type smart remote controller, the same manipulation or changed instruction may be applied to the apparatus 810. That is, a user is able to change a personalized home screen displayed on the apparatus 810 by editing and setting a personalized home screen displayed on the image reproducing screen 821. In more detail, the user is able to set the personalized home screen displayed on the image reproducing screen 821 by inputting various touch inputs, such as drag-and-drop, via a touch screen interface. In addition to the touch screen interface, the user is able to set the personalized home screen displayed on the image reproducing screen 821 by using the manipulation buttons 822. Moreover, the user is able to control overall operations of the apparatus 810 using the mirror-type smart remote controller 820, apart from editing a personalized home screen.

That is, for the functions described above, the mirror-type smart remote controller 820 includes a touch screen interface, a touch screen unit and an edition unit. In the case of an apparatus 810 for providing a personalized home screen, which corresponds to a user identified based on user identification information received from the user, the touch screen interface unit duplicates an image displayed in the apparatus 810 and then displays the duplicated image. In addition, the edition unit edits the personalized home screen based on an input which is received via the touch screen interface. Based on a touch input received from a user, the edition unit may edit a size and a location of an application which composes the personalized home screen by setting a layout of the personalized home screen. The mirror-type smart remote controller 820 may edit the personalized home screen using a voice instruction, a specific gesture or an eye movement which is received via a voice sensor or a motion sensor provided in the mirror-type smart remote controller 820.

In FIG. 8, it is possible to control the apparatus 810 and edit a personalized home screen using the mirror-type smart remote controller 820 which includes the image reproducing screen 821 and the manipulation buttons 822. However, the mirror-type smart remote controller 820 illustrated in FIG. 8 is merely an example, and aspects of the present invention are not limited thereto. The mirror-type smart remote controller 820 may include a TV remote controller, designed exclusively to control the apparatus 810, and various smart devices which includes a screen to play-back a video.

In particular, a smart device, such as a smart phone and a tablet PC, may be an example is of the mirror-type smart remote controller 820. That is, it is possible to control the apparatus 810 and edit a personalized home screen of the apparatus 810 using an application which is installed in a smart device and connected to the apparatus 810. If such a smart device is used like the mirror-type smart remote controller 820, it is not necessary to prepare an additional mirror-type smart remote controller 820. In addition, using a voice sensor or a motion sensor installed in the smart device, it is possible to recognize a voice instruction, a specific gesture or an eye movement to thereby control the apparatus 810 and edit a personalized home screen of the apparatus.

A user may change a location and a size of an icon for an application by inputting an instruction for shifting into an edit mode using the various input methods described above. In addition, the user may change a size and a resolution of a home screen. In particular, if a touch input interface provided in the mirror-type smart remote controller is used, it may be more convenient for a user to set a layout of the personalized home screen so as to edit configurations of a home screen and a size and a location of an execution screen of an application. The user transmits a control signal, such as an event or a multi-touch, to a TV using the mirror-type smart remote controller 820 so as to change a layout of a home screen in any way that the user wishes. The following are examples of a method for changing a layout of a home screen. It is possible to reduce or enlarge a size of a TV image screen using a multi-touch. In addition, it is possible to change a location of a TV image screen using a drag-and-drop function, change a size and a location of an icon for an installed application on the home screen, shift one page of a paginated home screen into another page, and classify applications into a plurality of groups.

In addition, the mirror-type smart remote controller 820 may play a role of a user identification unit illustrated in FIG. 1. Accordingly, a user may input information required for is user identification to the mirror-type smart remote controller 820.

The same features as those described above with reference to FIGS. 1 to 7 may be applied to the method explained in FIG. 8 for setting and editing a personalized home screen using the mirror-type smart remote controller 820 and recognizing a user.

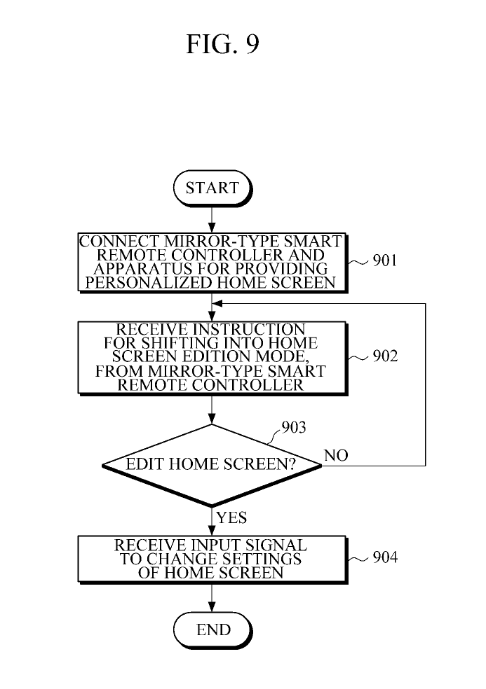

FIG. 9 is a flow chart illustrating a method for providing a personalized home screen using a mirror-type smart remote controller, according to an exemplary embodiment of the present invention.

Referring to FIG. 9, the method for providing a personalized home screen using a mirror-type smart remote controller starts out by connecting a mirror-type smart remote controller and an apparatus for providing a personalized home screen in operation 901. The mirror-type smart remote controller may be a remote controller which is designed exclusively for the apparatus for providing a personalized home screen. In addition, the mirror-type smart remote controller may be an application, which is installed in a smart device, a smart phone and a tablet PC, rather than an additionally provided remote controller. Using a telecommunication interface installed in a smart device, the mirror-type smart remote controller, such as a remote controller and a smart device for the apparatus, which are designed exclusively for the apparatus, may be connected to the apparatus via Near Field Communication (NFC), such as Infrared Communication and Bluetooth, wireless Local Area Network (LAN), such as WiFi, and 3G/Long Term Evolution (LTE) communication. A communication standard used for connecting the mirror-type smart remote controller and the apparatus is not limited to the above-mentioned communication standards, and may include various communication standards. In addition, a smart device, such as a smart phone and a tablet PC, may play a role of the mirror-type smart remote controller by executing an installed application so as to control the apparatus.

When the mirror-type smart remote controller is connected to the apparatus, the apparatus receives an instruction for shifting into a home screen edit mode from the mirror-type smart remote controller in operation 902. If a smart device is used as the mirror-type smart remote controller, an application installed in the smart device transmits the instruction for shifting into a home screen edit mode to the apparatus. The instruction for shifting into a home screen edit mode is an input signal being designed to change settings and configurations of a personalized home screen and a location of an application. When receiving an instruction for shifting into a home screen edit mode from the mirror-type smart remote controller, the apparatus determines whether to shift into a home screen edit mode to edit the personalized home screen in operation 903. If determining not to shift into a home screen edit mode, the apparatus waits until another input signal is received from the mirror-type smart remote controller.

If shifting into a home screen edit mode, the apparatus receives an input signal being designed to change settings of the personalized home screen from the mirror-type smart remote controller in operation 904. The input signal may include a signal for changing settings of the personalized home screen, applications, and a location and a size of an icon for an application. In addition, the input signal may be a signal for changing types of applications included in the personalized home screen or a size and a location of the personalized home screen. The same features as those described above with reference to FIGS. 1 to 8 may be applied to the processing for editing a personalized home screen and changing settings of the personalized home screen and the method for recognizing a user, the processing and the method described in operation 904.

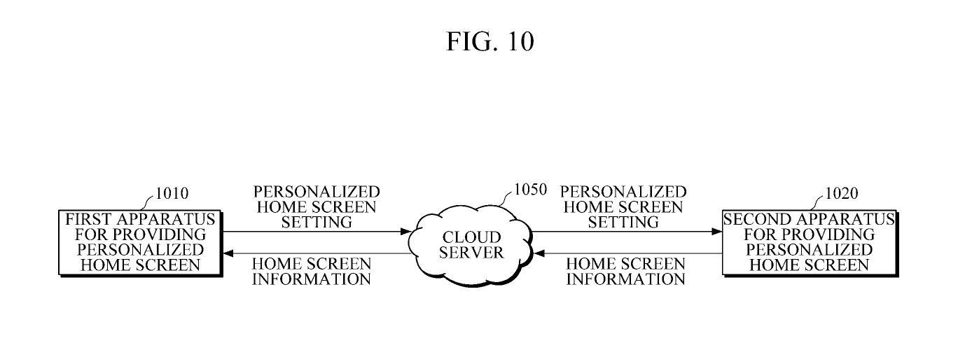

FIG. 10 is a diagram illustrating a configuration of a system for providing a personalized home screen, the system including two or more apparatuses for providing a personalized home screen, according to an exemplary embodiment of the present invention.

Referring to FIG. 10, the system for providing a personalized home screen, the system including two or more apparatus for providing a personalized home screen, includes a first apparatus 1010 for providing a personalized home screen and a second apparatus 1020 for providing a personalized home screen. The first apparatus 1010 and the second apparatus 1020 are connected to each other via a cloud server 1050 to thereby exchange personalized home screen setting information with each other and transmit and/or receive a personalized home screen setting signal from each other. That is, a user may edit a personalized home screen of the second apparatus 1020 using the first apparatus 1010 via the cloud server 1050.

If receiving a request for editing a personalized home screen from the first apparatus 1010, the second apparatus 1020 determines whether to confirm the request. If confirming the request, the second apparatus 1020 transmits home screen image information to the first apparatus 1010. The home screen information is information about a personalized home screen of the second apparatus 1020.

The first apparatus 1010 may check and edit the personalized home screen of the second apparatus 1020 using the received home screen information. The first apparatus 1010 may display the personalized home screen of the second apparatus 1020 in a specific area included in the personalized home screen of the first apparatus 1010, and may edit the personalized home screen of the second apparatus 1020 using the mirror-type smart remote controller. In this way, a user of the first apparatus 1010 is able to edit the personalized home screen of the second apparatus 1020 from a remote distance. For example, if parents living far from a child have difficulties editing a personalized home screen, the child is able to edit the personalized home screen on behalf of the parents.

The above-described FIGS. 1 to 10 are illustrated to explain how to recognize a user using various identification methods, provide a identified user with a personalized home screen and edit the personalized home screen by the user. However, according to an intention or purpose of a recognized user, a different person may be authorized to edit a personalized home screen.

It is possible to provide the same personalized home screen to users belonging to the same group, by classifying two or more users as one group. In addition, it is possible to authorize all users belonging to one group or to a representative user of a group to edit a personalized home screen. For example, all the family members may be classified as one group and only a father or mother may be authorized to edit a personalized home screen. In this case, a parent who is authorized to edit the personalized home screen is enabled to delete a TV channel or application, which is not appropriate for children to watch or enjoy, from the personalized home screen or to limit the use of the TV channel or application.

Using an apparatus and a method for providing a personalized home screen according to the above-described exemplary embodiments of the present invention, a user is able to be provided with a home screen suitable for the user in a smart TV, and with the same home screen in different smart TVs. Accordingly, each of users belonging to a household is able to use a home screen which is personalized according to personal tastes and usage patterns, so that a user may be provided with a desired piece of content more efficiently. In addition, a user may edit and rearrange a home screen in any way that the user wishes. Moreover, a user authorized as a manager may arbitrarily edit a home screen of a different family member. For example, if a parent is authorized as a manager, the parent may delete a piece of content or an application which needs to be prohibited to children. Furthermore, a user may change a home screen of a different user located in a different place by configuring a home screen and transmitting the configured home screen to the different user via a cloud server.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a personalized home screen, the apparatus comprising:
a user identification unit configured to receive user identification information including login information and biometric information of a user; and
a home screen processing unit configured to identify the user by comparing the received user identification information with a collection of user personal information of multiple users and searching for user personal information corresponding to the received user identification information, and to display a personalized home screen based on the user personalization information of the identified user.

2. The apparatus of claim 1, wherein the biometric information comprises at least one of iris information, fingerprint information, facial shape information and voice information.

3. The apparatus of claim 1, wherein the home screen processing unit stores user personal information including biometric information, home screen information including a layout, a theme and a GUI of a home screen, and usage pattern information including previous viewing history and bookmarks of a user.

4. The apparatus of claim 1, wherein the login information comprises identification (ID) and a password of the user.

5. The apparatus of claim 1, wherein, in response to not storing user personal information corresponding to the received user identification information, the home screen processing unit requests the user personal information from a cloud server storing the collection of user personal information of multiple users and receives the user personal information from the cloud server.

6. The apparatus of claim 5, wherein it is possible to display the personalized home screen in a different apparatus for providing a personalized home screen based on the user personal information received from the cloud server.

7. The apparatus of claim 5, wherein the apparatus is connected via the cloud server to the different apparatus, so that it is possible to edit a personalized home screen of the different apparatus using the apparatus from a remote distance.

8. The apparatus of claim 1, wherein the personalized home screen is generated based on home screen information comprising a layout, a theme and a Graphical User Interface (GUI) of a home screen, which are set in advance by the user, and usage pattern information including viewing history and bookmarks of the user.

9. The apparatus of claim 1, wherein the home screen processing unit classifies two or more users as one group and authorize one of users belonging to a same group to edit a personalized home screen used by all of the users.

10. A method for providing a personalized home screen, the method comprising:
collecting user identification information from a user;
comparing the collected user identification information with a collection of user personal information data of multiple users;
identifying the user based on user personal information corresponding to the user identification information; and
displaying a personalized home screen optimized for the user based on the user personal information.

11. The method of claim 10, wherein the user identification information comprises ID and a password necessary for a login process, biometric information of the user and a signal corresponding to the user, which is received from an input unit.

12. The method of claim 10, further comprising:
receiving the collection of user personal information of multiple users from a cloud server.

13. The method of claim 10, wherein the displaying of the personalized home screen comprises generating the personalized home screen which is optimized for the user based on home screen information, including a layout, a theme and a GUI of the personalized home screen, and usage pattern information including previous viewing history and bookmarks of the user.

14. A mirror-type smart remote controller comprising
a touch screen unit configured to have a touch screen interface, duplicate an image displayed in an apparatus for providing a personalized home screen, the apparatus which corresponds to a user identified based on user identification information received from the user, and display the duplicated image; and
an edit unit configured to edit a personalized home screen of the apparatus based on an input received via the touch screen interface.

15. The mirror-type smart remote controller of claim 14, wherein the mirror-type is remote controller comprises an application installed in a smart device.

16. The mirror-type smart remote controller of claim 14, wherein the edit unit edits a size or a location of an application composing the personalized home screen and sets a layout of the personalized home screen based on a touch input received from the user.

17. The mirror-type remote controller of claim 14, wherein the mirror-type smart remote controller edits the personalized home screen using one of a voice instruction, a predetermined gesture and an eye movement which are received using a voice sensor and a motion sensor installed in the mirror-type remote controller.

18. A system for providing a personalized home screen, the system comprising
a cloud server configured to store personal information on each of a plurality of users and personalized home screens corresponding to each of the plurality of users,
two or more apparatuses for providing a personalized home screen, each apparatus configured to display a personalized home screen corresponding to a user who is identified based on user identification information received from the user and edit a personalized home screen of the other apparatus via the cloud server.

19. The system of claim 18, wherein one of the two or more apparatuses for providing a personalized home screen shares a personalized home screen thereof with the other apparatus via the cloud server.
